(19) United States
(12) Patent Application Publication
(10) Pub. No.: US 2007/0124530 A1
(43) Pub. Date: May 31, 2007

(54) Portable electronic device and control method of portable electronic device

(75) Inventor: Norio Ishibashi, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/514,965

(22) Filed: Sep. 5, 2006

(30) Foreign Application Priority Data
Oct. 5, 2005 (JP) 2005-292680

(51) Int. Cl. G06F 12/02; G06F 12/00

(52) U.S. Cl. 711/1

(57) ABSTRACT

An IC card has a memory storing record files having management information and record data. When receiving a record-based command which specifies a record file stored in the memory, the IC card processes data stored in the file for each of the specified records. When receiving a binary-based command which specifies a record file, the IC card processes, as binary data, data in which the record data in the respective records stored in the file or the management information and the record data in the respective records are combined in ascending order or descending order.

### CROSS-REFERENCE TO RELATED APPLICATIONS

This application is based upon and claims the benefit of priority from prior Japanese Patent Application No. 2005-292680, filed Oct. 5, 2005, the entire contents of which are incorporated herein by reference.

### BACKGROUND OF THE INVENTION

1. Field of the Invention

This invention relates to a portable electronic device such as an IC card which has, for example, a nonvolatile memory capable of writing and rewriting data and a control element such as a CPU and which executes processing complying with a command input from the external.

2. Description of the Related Art

Heretofore, as a portable electronic device, there has been an IC card in which an IC module having functions of a memory, a CPU, etc. is buried in a case constructed by plastic plates and others. In such an IC card, data is written into a rewritable nonvolatile memory in response to a command from an external device, or data is read from the nonvolatile memory. For example, in ISO7816 which is a standard specification of the IC card, a transparent elementary file (EF) and a record EF, etc. are defined as file data structures for data to be stored in the nonvolatile memory of the IC card.

Unstructured data (binary data) is stored in the transparent EF. In conventional IC cards, the data stored in such a transparent EF is only accessed by a binary-based command. Therefore, the transparent EF has a high degree of freedom in the structure of data.

Furthermore, the record EF stores, as data, records in a predetermined format having management information and actual data (record data). Thus, management of data is easy in the record EF. In the conventional IC cards, the data (records) stored in such a record EF is only accessed by a record-based command.

In the case of the binary-based command, a higher-level device specifies the access to the data in the EF by offset. Thus, the binary-based command enables the data in the EF to be collectively specified as a processing target, and processing in the IC card for the binary-based command is simple. However, in the case of the binary-based command, because it is necessary to directly specify the data in the EF to be the processing target, desired data can not be specified as the processing target if, for example, the data structure in the EF is not known.

On the contrary, in the case of the record-based command, the higher-level device specifies, for the IC card, the access to the data in the EF by the record. Therefore, in the higher-level device, it is easy to specify the data (record) in the IC card. However, in the case of the record-based command, because it is necessary to specify data to be the processing target record by record, a plurality of record-based commands has to be used to specify each record as the processing target even when a plurality of records in the EF is specified as the processing targets.

In particular, in the portable electronic device such as the IC card, processing time is often limited in the mode of employment. Thus, in the portable electronic device such as the IC card, there has been a demand for an increased speed of processing or simplification of processing through efficient access to the data stored in the memory.

### BRIEF SUMMARY OF THE INVENTION

One mode of this invention is directed to provide a portable electronic device capable of efficient access to data, and a control method of a portable electronic device.

A portable electronic device as one mode of this invention comprises: a memory which stores files storing records having management information and record data; a communication unit which performs data communication with an external device; and a processing unit which processes, as binary data, data in the respective records stored in the file when receiving, through the communication unit, a binary command for binary data processing which specifies the file storing the records stored in the memory.

A control method of a portable electronic device as one mode of this invention comprises: receiving a command requesting data processing from an external device; judging whether or not the command received from the external device is a binary command for binary data processing which specifies a file storing records stored in the memory and having management information and record data; and processing the data in the respective records stored in the file as binary data when the command received from the external device is judged as the binary command which specifies the file storing the records.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram schematically showing the configuration of hardware of an IC card 1 as a portable electronic device according to an embodiment of this invention;

FIG. 2 is a diagram showing an example of the configuration of files stored in a nonvolatile memory;

FIG. 3 is a diagram showing an example of the configuration of data stored in a record EF;

FIG. 4 is a flowchart for explaining a first processing example;

FIG. 5 is a flowchart for explaining a second processing example;

FIG. 6 is a flowchart for explaining a third processing example;

FIG. 7 is a flowchart for explaining a fourth processing example; and

FIG. 8 is a flowchart for explaining a fifth processing example.

### DETAILED DESCRIPTION OF THE INVENTION

A preferred embodiment for carrying out this invention will hereinafter be described with reference to the drawings.

It is to be noted that an IC card is assumed as a portable electronic device in the embodiment described below. Furthermore, the present embodiment can also be applied to electronic devices such as IC card to be set in a mobile telephone.

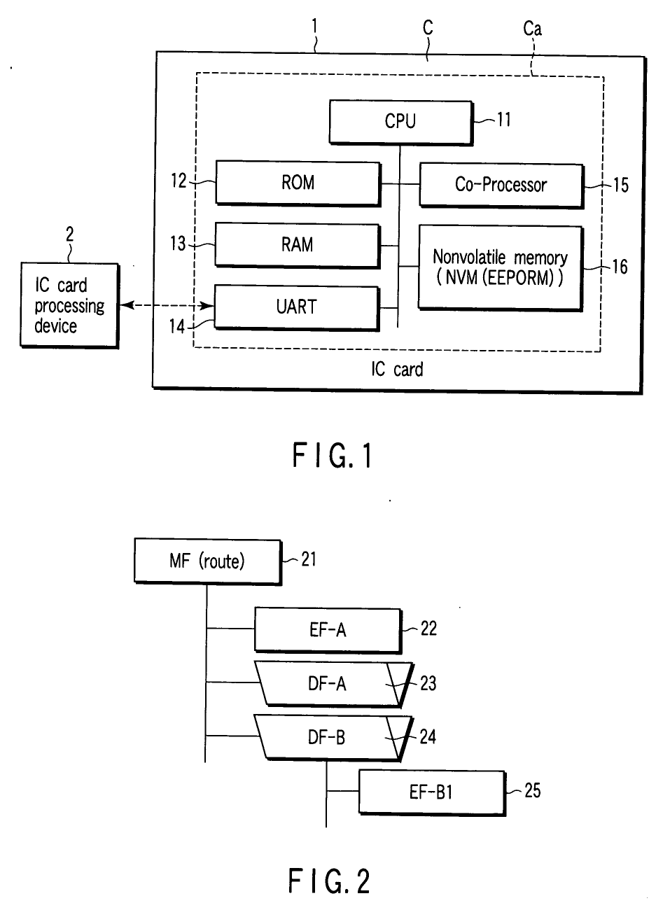

FIG. 1 schematically shows the configuration of hardware of an IC card 1 as a portable electronic device according to this embodiment.

As shown in FIG. 1, the IC card 1 has, for example, a central processing unit (CPU) 11, a read only memory (ROM) 12, a random access memory (RAM) 13, a communication unit (UART) 14, a co-processor 15 and a nonvolatile memory (NV (EEPROM)) 16.

The CPU 11, the ROM 12, the RAM 13, the communication unit 14, the co-processor 15 and the nonvolatile memory 16 are constructed by a module Ca integrally formed by an IC chip or the like. This module Ca is buried in a case C forming the IC card 1. That is, the IC card 1 is constructed by the case C in which the module Ca is buried.

Furthermore, when supplied with, for example, electric power from an IC card processing device 2 as a higher-level device, the IC card 1 is activated (brought into an operable state), and operates in accordance with a command from the IC card processing device 2.

The CPU 11 is responsible for overall management and control. The CPU 11 functions as, for example, a processing unit and a judging unit. The CPU 11 operates on the basis of a control program or the like to perform various kinds of processing. The ROM 12 is a nonvolatile memory in which the control program, control data, etc. are prestored. The RAM 13 is a volatile memory which functions as a working memory.

The communication unit 14 functions as a communication part, and controls data communication with the IC card processing device 2 as the higher-level device. The communication unit 14 also functions as means for receiving electric power for operating the IC card 1. The co-processor 15 assists in a calculation such as encryption or decryption. The nonvolatile memory 16 is a rewritable nonvolatile memory for storing various kinds of data and applications (application programs). It is to be noted that the structure of data stored in the nonvolatile memory 16 will be described later in detail.

Furthermore, the communication unit 14 has a configuration complying with the communication method of the IC card 1. For example, when the IC card 1 has a contact-type communication method, the communication unit 14 comprises a contact section or the like for physically contacting the contact section of the IC card processing device 2 as the higher-level device. In this case, the IC card 1 receives the electric power from the IC card processing device 2 by the communication unit 14 which is in physical contact with the IC card processing device 2. That is, when the IC card 1 is a contact-type IC card, the IC card 1 receives the operating electric supply and an operation clock from the IC card processing device 2 via the contact section as the communication unit 14, and is thus activated.

Moreover, when the IC card 1 has a contactless-type (wireless) communication method, the communication unit 14 comprises an antenna for transmitting and receiving radio waves, a communication control section for controlling communication, etc. In this case, the IC card 1 generates by an unshown power source unit the operating electric power and the operation clock from the radio waves received by the communication unit 14. That is, when the IC card 1 is a contactless-type IC card, the IC card 1 receives the radio waves from the IC card processing device 2 via the antenna, the communication control section, etc. as the communication unit 14, generates the operating electric power supply and the operation clock from the radio waves by the unshown power source unit, and is thus activated.

Next, the configuration of data stored in the nonvolatile memory 16 will be described.

Various kinds of data are stored in the nonvolatile memory 16 in a file structure defined in, for example, ISO/IEC7816. For example, a file as a data file managed in a multiple layer structure (tree structure) (EF: elementary file), and a file as a data folder (DF: dedicated file) are stored in the nonvolatile memory 16.

FIG. 2 is a diagram showing an example of the configuration of the files stored in the nonvolatile memory 16.

In the example shown in FIG. 2, the top level has a file as a master file (MF) 21. Under the MF 21, there are provided an EF (EF-A) 22 storing data, a DF (DF-A) 23 as a folder, and a DF (DF-B) 24 as a folder. Further, under the DF (DF-B) 24, there is provided an EF (EF-B1) 25 used for, for example, storing data. In such a file structure, various kinds of data are stored in the EF as the data file.

Next, the configuration of the EF as the data file stored in the nonvolatile memory 16 will be described.

As described above, various kinds of data are stored in the EFs in the nonvolatile memory 16 of the IC card 1. For example, a transparent EF, a record EF, etc. are defined as data structures in the EF in, for example, ISO7816 which is a standard specification of the IC card.

The transparent EF is a file for storing a series of unstructured data. Data stored in the transparent EF is treated by offset specification. Thus, processing for the transparent EF is simple. Moreover, the structure of data stored in the transparent EF has a degree of freedom. Therefore, the transparent EF is suitable when the data is managed by the IC card processing device 2 as the higher-level device of the IC card 1.

On the contrary, the record EF is a file for storing one or a plurality of data (records) structured in a predetermined format. Each record stored in the record EF is data in a predetermined format having management information and record data. The management information in each record stored in the record EF includes information such as information on the order of records (record number) and checksum data (validity confirmation data, parity). Further, the record data (actual data) in each record stored in the record EF is composed of a tag as identification information, length as information indicating the data length of a data value, and a value as the data value.

As described above, the record EF stores data per record in the predetermined format. Thus, in order to access data stored in the record EF, it is necessary to specify a record storing the data. In other words, the data in the record EF can be treated by the record specification. Thus, in the data stored in the record EF, data (record) management is possible, such as the confirmation of the validity of the record structure, and record retrieval by the tag. This means that the IC card processing device 2 as the higher-level device which requests the IC card 1 for processing (supplies a command) can treat data by structured records.

A binary-based command is used for the transparent EF. For example, a command called write binary is used to write data into the transparent EF. Moreover, a command called read binary is used to read data from the transparent EF.

On the contrary, in order to access the record EF, both the record-based command and the binary-based command can be used in the IC card 1. That is, the commands for writing data into the record EF include, as the record-based commands, commands such as write record, update record and append record, and as the binary-based command, a command such as write binary. Moreover, the commands for reading data from the record EF include, as the record-based command, a command such as read record, and as the binary-based command, a command such as read binary.

As described above, the IC card 1 can access the record EF with the record-based command or the binary-based command. In other words, the IC card 1 can access the data stored in the record EF per record (access as the record EF) when receiving the record-based command, and the IC card 1 can access, as binary data, the data stored in the record EF per record (access it as a pseudo transparent EF) when receiving the binary-based command.

For example, a case is assumed where ten records are stored in one record EF. In this case, in order to use the record-based command (read record command) to read all of the ten records stored in one record EF, the IC card 1 needs to execute the read record command ten times. On the contrary, in order to use the binary-based command (read binary command) to read all of the ten records stored in one record EF, the IC card 1 only needs to execute the read binary command one time. This is based on the assumption that the IC card 1 combines data stored as the ten records and treats the data as one binary data in response to the read binary command that specifies the record EF.

Next, the configuration of data stored in the record EF will be described.

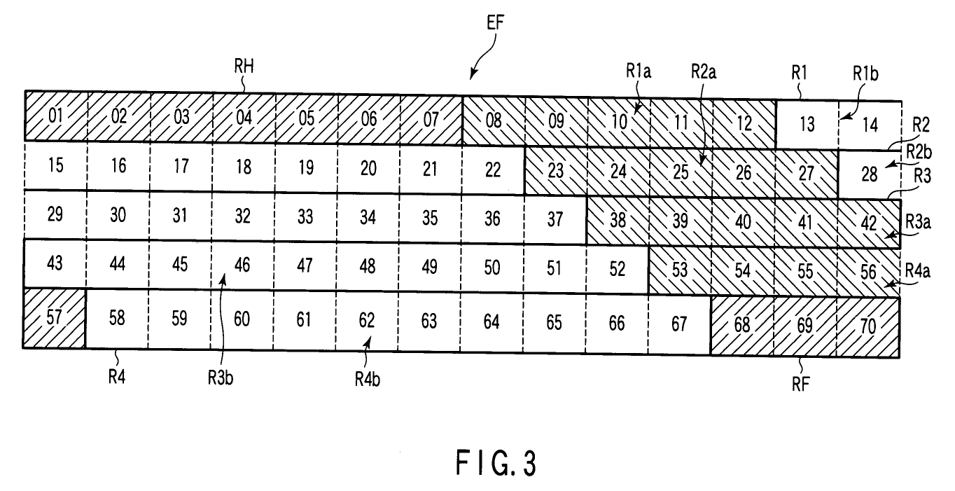

FIG. 3 shows an example of the configuration of data stored in the record EF.

In the example shown in FIG. 3, one byte is expressed by one cell. In the example shown in FIG. 3, the entire EF comprises 70 bytes. Further, in the EF shown in FIG. 3, write cells (“13” to “22”, “28” to “37”, “43” to “52”, “58” to “67”) indicate the identification information (tag), the length information (length) and the data value (value) as the actual data for the respective records. Cells with lines slanting to the right (“08” to “12”, “23” to “27”, “38” to “42”, “53” to “57”) indicate data on the management information in the respective records. Cells with lines slanting to the left (“01” to “07”, “68” to “70”) indicate data such as the management information for the entire EF.

That is, in the EF shown in FIG. 3, management information RH and RF for the EF, and four records R1, R2, R3 and R4 are stored. The management information RH and RF for the EF are constituted of the bytes of “01” to “07” and the bytes of “68” to “70”.

Furthermore, the first record R1 is constituted of the bytes of “08” to “22”. Moreover, the first record R1 has management information R1a stored in the bytes of “08” to “12”, and record data R1b stored in the bytes of “13” to “22”.

Still further, the second record R2 is constituted of the bytes of “23” to “37”. Moreover, the second record R2 has management information R2a stored in the bytes of “23” to “27”, and record data R2b stored in the bytes of “28” to “37”.

Still further, the third record R3 is constituted of the bytes of “38” to “52”. Moreover, the third record R3 has management information R3a stored in the bytes of “38” to “42”, and record data R3b stored in the bytes of “43” to “52”.

Still further, the fourth record R4 is constituted of the bytes of “53” to “57”. Moreover, the fourth record R4 has management information R4a stored in the bytes of “53” to “57”, and record data R4b stored in the bytes of “58” to “67”.

Next, access to the data in the record EF will be described.

First, processing of the data in the record EF by the record-based command will be described.

Here, as an example of processing the data in the record EF by the record-based command, a case will be described wherein the read record command is used to read all the data (all the records) from the record EF storing a plurality of records.

For example, the read record command can be used as the record-based command to read the data stored in the record EF as described above. In the IC card which has received this read record command, the data is read for each record in the record EF specified by the command.

Here, a case will be described wherein the read record command is used to read the data in each record (record data in all the records) stored in the record EF as shown in FIG. 3.

First, the IC card processing device 2 transmits a first read record command specifying the first record R1 in the record EF. On receipt of the first read record command, the IC card 1 reads the record data (“13” to “22”) R1a of the first record R1 in the record EF from the nonvolatile memory 16. Thus, the IC card 1 outputs, to the IC card processing device 2, the record data R1b of 10 bytes in the first record R1 as a response to the first read record command.

On receipt of the record data R1b of the first record R1 as a response to the first read record command, the IC card processing device 2 outputs a second read record command specifying the second record R2. On receipt of the second read record command, the IC card 1 reads the record data (“28” to “37”) R2a of the second record R2 in the record EF from the nonvolatile memory 16. Thus, the IC card 1 outputs, to the IC card processing device 2, the record data R2b of 10 bytes in the second record R2 as a response to the second read record command.

On receipt of the record data R2b of the second record R2 as a response to the second read record command, the IC card processing device 2 outputs a third read record command specifying the third record R3. On receipt of the third read record command, the IC card 1 reads the record data (“43” to “52”) R3a of the third record R3 in the record EF from the nonvolatile memory 16. Thus, the IC card 1 outputs, to the IC card processing device 2, the record data R3b of 10 bytes in the third record R3 as a response to the third read record command.

On receipt of the record data R3b of the third record R3 as a response to the third read record command, the IC card processing device 2 outputs a fourth read record command specifying the fourth record R4. On receipt of the fourth read record command, the IC card 1 reads the record data (“58” to “67”) R4a of the fourth record R4 in the record EF from the nonvolatile memory 16. Thus, the IC card 1 outputs, to the IC card processing device 2, the record data R4b of 10 bytes in the fourth record R4 as a response to the fourth read record command.

On receipt of the record data R4b of the fourth record R4 as a response to the fourth read record command, the IC card processing device 2 obtains the data of all the records in the record EF.

That is, when a plurality of records stored in one record EF is accessed, each record to be accessed is specified in the case of the record-based command. For example, in order to read all the data in the record EF in which there is a plurality of records (all the records in the record EF), a read code command as the record-based command has to be executed as many times as the number of records present in the record EF.

Next, access to the data in the record EF by the binary-based command will be described.

In the present embodiment, first to fifth processing examples will be described as examples of processing of the data in the record EF by the binary-based command.

First, the first example of processing in response to a binary-based command specifying the record EF will be described.

For example, the read binary command can be used as the binary-based command to read the data stored in the record EF as described above. When such a read binary command (binary-based command) specifying the record EF is received, data in which record data in the respective records stored in the record EF specified by the command are combined in ascending order is read as binary data in the first processing example.

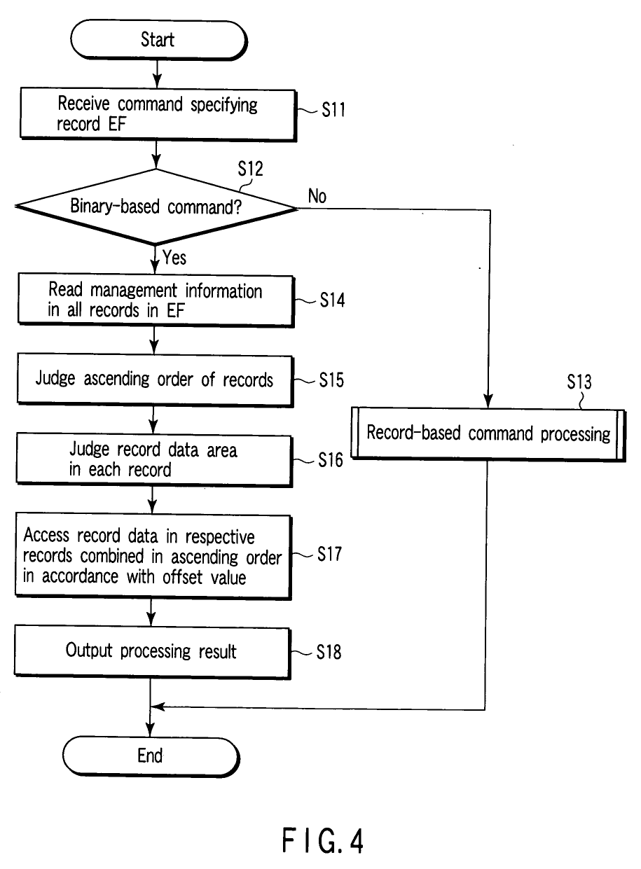

FIG. 4 is a flowchart for explaining the first processing example.

As shown in FIG. 4, the IC card 1 first receives a command (e.g., read command) specifying the record EF from the IC card processing device 2 (step S11). Then, the CPU 11 of the IC card 1 judges whether the received command is a record-based command (e.g., read record command) or a binary-based command (e.g., read binary command) (step S12).

When this judgment is that the received command is a record-based command (e.g., read record command) (step S12, NO), the CPU 11 of the IC card 1 executes the processing of accessing (e.g., processing of reading) the record specified by the command among the records present in the record EF (step S13).

Furthermore, when the judgment is that the received command is a binary-based command (e.g., read binary command) (step S12, YES), the CPU 11 of the IC card 1 reads the management information for all the records present in the record EF specified by the command (step S14).

When the management information for all the records in the record EF is read, the CPU 11 judges the ascending order of the records on the basis of the management information in the respective records (step S15). Here, the ascending order of the records may be the ascending order of date of the records when stored in the EF (or data of update of the record data) or may be the ascending order of size of identification information (e.g., record numbers) of the records assigned to the records as the management information. For example, when the record numbers are assigned to the records in order in the record EF which stores the history of processing as records, the record data in the respective records are arranged in ascending order of the record numbers, such that the record data as processing history information are arranged in ascending order of history.

Furthermore, the CPU 11 judges the ascending order of the records, and also judges storage areas for the record data in each record on the basis of the management information for each record (step S16). The storage areas for the record data in each record are judged, for example, on the basis of the information (length) indicating the length of data stored in each record.

When the ascending order of the records and the storage areas for the record data in each record have been judged, the CPU 11 executes the processing (e.g., reading processing) requested by the command for the data in the respective records in the record EF that are arranged in ascending order (step S17). Moreover, an offset value indicating a start position of access is specified in the binary-based command (e.g., read binary command). Thus, in step S17, the CPU 11 performs the processing for data from the offset value specified by the command out of the data in which the record data in the respective records in the record EF are arranged in ascending order (data combined in ascending order).

When the processing requested by the binary-based command is terminated, the CPU 11 transmits a processing result as a response to the IC card processing device 2, and terminates the processing corresponding to the command (step S18). For example, when the received command is a read binary command whose offset value is n, the CPU 11 performs the processing of reading data from an n-th byte out of the data in which the record data in the respective records in the record EF are arranged in ascending order, and transmitting the read data to the IC card processing device 2.

As a specific example of the first processing, a case will be described wherein a read binary command specifying the record EF as shown in FIG. 3 is received.

In this case, the IC card 1 in the first processing example reads, as binary data, data specified by the offset value out of the data in which the record data alone in the respective records are combined in the order (ascending order) from the first record R1 to the fourth record R4, and outputs the data as a response to the read binary command.

For example, when the offset value of the read binary command specifying the record EF shown in FIG. 3 is “0”, the IC card 1 reads, as binary data, all the data in which the record data alone in the respective records are combined in the order (ascending order) from the first record R1 to the fourth record R4. That is, in response to the read binary command specifying the record EF shown in FIG. 3 and having an offset value “0”, the IC card 1 in the first processing reads and outputs 40 bytes of data that are arranged in the following order: “13” to “22” (the record data R1b of the first record R1), “28” to “37” (the record data R2b of the second record R2), “43” to “52” (the record data R3b of the third record R3), and “58” to “67” (the record data R4b of the fourth record R4).

Furthermore, when the offset value of the read binary command specifying the record EF shown in FIG. 3 is “7”, the IC card 1 reads, as binary data, the data from the seventh byte out of the data in which the record data alone in the respective records are combined in the order (ascending order) from the first record R1 to the fourth record R4. That is, in response to the read binary command specifying the record EF shown in FIG. 3 and having an offset value “7”, the IC card 1 in the first processing reads and outputs 33 bytes of data that are arranged in the following order: “20” which is the data of the seventh byte from “13”, to “22” (the record data R1b of the first record R1 excepting the seven bytes of data from the head), “28” to “37” (the record data R2b of the second record R2), “43” to “52” (the record data R3b of the third record R3), and “58” to “67” (the record data R4b of the fourth record R4).

As described above, in the first processing example, when the record-based command specifying the record EF is received, a particular record in the EF specified by the command is accessed. When the binary-based command specifying the record EF is received, the data in which the record data in the respective records in the EF are combined in ascending order is accessed.

That is, in the first processing example, when the record-based command specifying the record EF is received, the EF is treated as a record EF to be processed for each of the specified records. When the binary-based command specifying the record EF is received, the data in which the record data in the respective records in the record EF are combined in ascending order is processed as binary data.

Thus, in the first processing example, the record EF can be treated as a pseudo transparent EF. As a result, in the first processing example, it is possible to efficiently access the data stored in the record EF.

Furthermore, in the first processing example, when the binary-based command specifying the record EF is received, the data in which the record data in the respective records are combined in ascending order is treated as binary data.

This makes it possible to collectively process the data in which the record data in the respective records are combined in ascending order. For example, when the processing history information (log data) is stored in the record EF as records to which the record numbers are assigned one by one in order, it is possible to perform, by the binary-based command such as the read binary command, processing of, for example, collectively reading the log data by which information on a plurality of pieces of processing is arranged in ascending order of history.

Next, the second example of processing in response to a binary-based command specifying the record EF will be described.

For example, the read binary command can be used as the binary-based command to read the data stored in the record EF as described above. When such a read binary command (binary-based command) specifying the record EF is received, data in which management information and record data in the respective records stored in the record EF specified by the command are combined in ascending order is read as binary data in the second processing example.

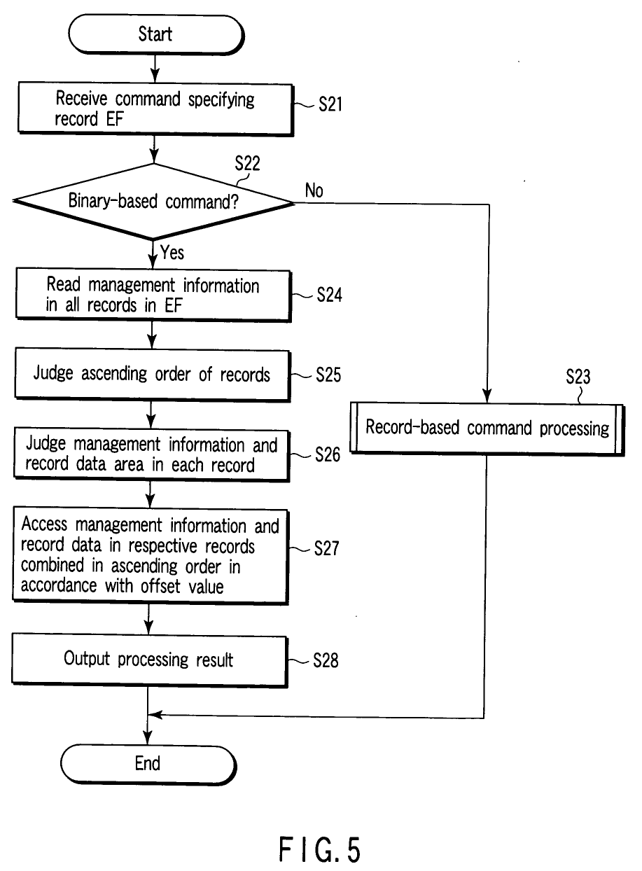

FIG. 5 is a flowchart for explaining the second processing example.

As shown in FIG. 5, the IC card 1 first receives a command (e.g., read command) specifying the record EF from the IC card processing device 2 (step S21). Then, the CPU 11 of the IC card 1 judges whether the received command is a record-based command (e.g., read record command) or a binary-based command (e.g., read binary command) (step S22).

When this judgment is that the received command is a record-based command (e.g., read record command) (step S22, NO), the CPU 11 of the IC card 1 executes the processing (e.g., reading processing) of the record specified by the command among the records present in the record EF (step S23).

Furthermore, when the judgment is that the received command is a binary-based command (e.g., read binary command) (step S22, YES), the CPU 11 of the IC card 1 reads the management information for all the records present in the record EF specified by the command (step S24).

When the management information for all the records in the record EF is read, the CPU 11 judges the ascending order of the records on the basis of the management information in the respective records (step S25). Here, the ascending order of the records may be the ascending order of date of the records when stored in the EF (or data of update of the record data) or may be the ascending order of size of identification information (e.g., record numbers) of the records assigned to the records as the management information. For example, when the record numbers are assigned to the records in order in the record EF which stores the history of processing as records, the management information and the record data in the respective records are arranged in ascending order of the record numbers, such that the management information and the processing history information are arranged in ascending order of history.

Furthermore, the CPU 11 judges the ascending order of the records, and also judges storage areas for the management information and the record data in each record on the basis of the management information for each record (step S26). The storage areas for the management information and the record data in each record are judged, for example, on the basis of the information (length) indicating the length of data stored in each record.

When the ascending order of the records and the storage areas for the management information and the record data in each record have been judged, the CPU 11 executes the processing (e.g., reading processing) requested by the command for the data in which the management information and the record data in the respective records in the record EF are arranged in ascending order (step S27). Moreover, an offset value indicating a start position of access is specified in the binary-based command (e.g., read binary command). Thus, in step S27, the CPU 11 performs the processing for data from the offset value specified by the command out of the data in which the management information and the record data in the respective records in the record EF are arranged in ascending order (data combined in ascending order).

When the processing requested by the binary-based command is terminated, the CPU 11 transmits a processing result as a response to the IC card processing device 2, and terminates the processing corresponding to the command (step S28). For example, when the received command is a read binary command whose offset value is n, the CPU 11 performs the processing of reading data from an n-th byte out of the data in which the management information and the record data in the respective records in the record EF are arranged in ascending order, and transmitting the read data to the IC card processing device 2.

As a specific example of the second processing, a case will be described wherein a read binary command specifying the record EF as shown in FIG. 3 is received.

In this case, the IC card 1 in the second processing example reads, as binary data, data specified by the offset value out of the data in which the management information and the record data in the respective records are combined in the order (ascending order) from the first record R1 to the fourth record R4, and outputs the data as a response to the read binary command.

For example, when the offset value of the read binary command specifying the record EF shown in FIG. 3 is “0”, the IC card 1 reads, as binary data, all the data in which the record data alone in the respective records are combined in the order (ascending order) from the first record R1 to the fourth record R4. That is, in response to the read binary command specifying the record EF shown in FIG. 3 and having an offset value “0”, the IC card 1 in the second processing reads and outputs 60 bytes of data that are arranged in the following order: “08” to “12” (the management information R1a of the first record R1), “13” to “22” (the record data R1b of the first record R1), “23” to “27” (the management information R2a of the second record R2), “28” to “37” (the record data R2b of the second record R2), “38” to “42” (the management information R3a of the third record R3), “43” to “52” (the record data R3b of the third record R3), “53” to “57” (the management information R4a of the fourth record R4) and “58” to “67” (the record data R4b of the fourth record R4).

Furthermore, when the offset value of the read binary command specifying the record EF shown in FIG. 3 is “7”, the IC card 1 reads, as binary data, the data from the seventh byte out of the data in which the management information and the record data in the respective records are combined in the order (ascending order) from the first record R1 to the fourth record R4. That is, in response to the read binary command specifying the record EF shown in FIG. 3 and having an offset value “7”, the IC card 1 in the second processing reads and outputs 53 bytes of data that are arranged in the following order: “15”, which is the data of the seventh byte from “08” (“08” to “12”, “13” to “14”), to “22” (data excepting five bytes of the management information R1a of the first record R1 and 2 bytes of data from the head of the record data R1b), “23” to “37” (the management information R2a and the record data R2b of the second record R2), “38” to “52” (the management information R3a and the record data R3b of the third record R3), and “53” to “67” (the management information R4a and the record data R4b of the fourth record R4).

As described above, in the second processing example, when the record-based command specifying the record EF is received, a particular record in the EF specified by the command is accessed. When the binary-based command specifying the record EF is received, the data in which the management information and the record data in the respective records in the EF are combined in ascending order is accessed.

That is, in the second processing example, when the record-based command specifying the record EF is received, the data in the EF is treated as a record EF to be processed for each of the specified records When the binary-based command specifying the record EF is received, the data in which the management information and the record data in the respective records in the record EF are combined in ascending order is processed as binary data. Thus, the record EF is treated as a pseudo transparent EF.

In this manner, in the second processing example, it is possible to efficiently access the data stored in the record EF.

Furthermore, in the second processing example, when the binary-based command specifying the record EF is received, the data in which the management information and the record data in the respective records are combined in ascending order is treated as binary data. This makes it possible to collectively process the data in which the management information and the record data in the respective records are combined in ascending order. For example, when the processing history information (log data) is stored in the record EF as records to which the record numbers are assigned one by one in order, it is possible to perform, by the binary-based command such as the read binary command, processing of, for example, collectively reading the management information and the log data by which a plurality of pieces of processing is arranged in ascending order of history.

Next, the third example of processing in response to a binary-based command specifying the record EF will be described.

For example, the read binary command can be used as the binary-based command to read the data stored in the record EF as described above. When such a read binary command (binary-based command) specifying the record EF is received, data in which the record data in the respective records stored in the record EF specified by the command are combined in descending order is read as binary data in the third processing example.

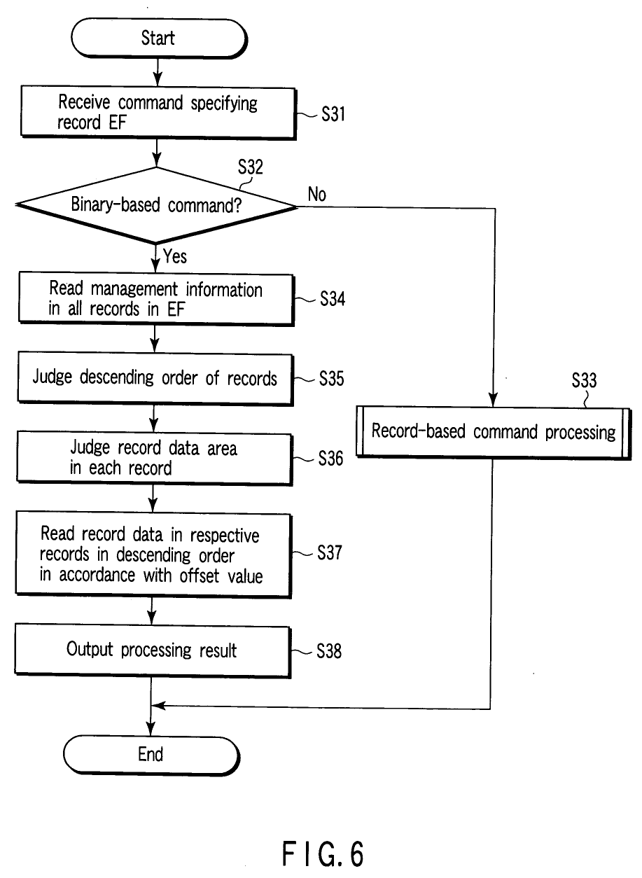

FIG. 6 is a flowchart for explaining the third processing example.

As shown in FIG. 6, the IC card 1 first receives a command (e.g., read command) specifying the record EF from the IC card processing device 2 (step S31). Then, the CPU 11 of the IC card 1 judges whether the received command is a record-based command (e.g., read record command) or a binary-based command (e.g., read binary command) (step S32).

When this judgment is that the received command is a record-based command (e.g., read record command) (step S32, NO), the CPU 11 of the IC card 1 executes the processing of accessing (e.g., processing of reading) the record specified by the command among the records present in the record EF (step S33).

Furthermore, when the judgment is that the received command is a binary-based command (e.g., read binary command) (step S32, YES), the CPU 11 of the IC card 1 reads the management information for all the records present in the record EF specified by the command (step S34).

When the management information for all the records in the record EF is read, the CPU 11 judges the descending order of the records on the basis of the management information in the respective records (step S35). Here, the descending order of the records may be the descending order of date of the records when stored in the EF (or data of update of the record data) or may be the descending order of size of identification information of the records assigned to the records as the management information. For example, when the record numbers are assigned to the records in order in the record EF which stores the history of processing as records, the record data in the respective records are arranged in descending order of the record numbers, such that the record data as processing history information are arranged in descending order of history.

Furthermore, the CPU 11 judges the descending order of the records, and also judges storage areas for the record data in each record on the basis of the management information for each record (step S36). The storage areas for the record data in each record are judged, for example, on the basis of the information (length) indicating the length of data stored in each record.

When the descending order of the records and the storage areas for the record data in each record have been judged, the CPU 11 executes the processing (e.g., reading processing) requested by the command for the data in which the record data in the respective records in the record EF are arranged in descending order (step S37). Moreover, an offset value indicating a start position of access is specified in the binary-based command (e.g., read binary command). Thus, in step S37, the CPU 11 performs the processing for data from the offset value specified by the command out of the data in which the record data in the respective records in the record EF are arranged in descending order (data combined in descending order).

When the processing requested by the binary-based command is terminated, the CPU 11 transmits a processing result as a response to the IC card processing device 2, and terminates the processing corresponding to the command (step S38). For example, when the received command is a read binary command whose offset value is n, the CPU 11 performs the processing of reading data from an n-th byte out of the data in which the record data in the respective records in the record EF are arranged in descending order, and transmitting the read data to the IC card processing device 2.

As a specific example of the third processing, a case will be described wherein a read binary command specifying the record EF as shown in FIG. 3 is received.

In this case, the IC card 1 in the third processing example reads, as binary data, data specified by the offset value out of the data in which the record data alone in the respective records are combined in the order (descending order) from the fourth record R4 to the first record R1, and outputs the data as a response to the read binary command.

For example, when the offset value of the read binary command specifying the record EF shown in FIG. 3 is “0”, the IC card 1 reads, as binary data, all the data in which the record data alone in the respective records are combined in the order (descending order) from the fourth record R4 to the first record R1. That is, in response to the read binary command specifying the record EF shown in FIG. 3 and having an offset value “0”, the IC card 1 in the third processing reads and outputs 40 bytes of data that are arranged in the following order: “58” to “67” (the record data R4b of the fourth record R4), “43” to “52” (the record data R3b of the third record R3), “28” to “37” (the record data R2b of the second record R2), and “13” to “22” (the record data R1b of the first record R1).

Furthermore, when the offset value of the read binary command specifying the record EF shown in FIG. 3 is “7”, the IC card 1 reads, as binary data, the data from the seventh byte out of the data in which the record data alone in the respective records are combined in the order (descending order) from the fourth record R4 to the first record R1. That is, in response to the read binary command specifying the record EF shown in FIG. 3 and having an offset value “7”, the IC card 1 in the third processing reads and outputs 33 bytes of data that are arranged in the following order: “65”, which is the data of the seventh byte from “58”, to “67” (the record data R4b of the fourth record R4 excepting the seven bytes of data from the head), “43” to “52” (the record data R3b of the third record R3), “28” to “37” (the record data R2b of the second record R2), and “13” to “22” (the record data R1b of the first record R1).

As described above, in the third processing example, when the record-based command specifying the record EF is received, a particular record in the EF specified by the command is accessed. When the binary-based command specifying the record EF is received, the data in which the record data in the respective records in the EF are combined in descending order is accessed.

That is, in the third processing example, when the record-based command specifying the record EF is received, the record EF is treated as a record EF to be processed for each of the specified records. When the binary-based command specifying the record EF is received, the data in which the record data in the respective records in the record EF are combined in descending order is processed as binary data. Thus, the record EF is treated as a pseudo transparent EF.

In this manner, in the third processing example, it is possible to efficiently access the data stored in the record EF.

Furthermore, in the third processing example, when the binary-based command specifying the record EF is received, the data in which the record data in the respective records are combined in descending order is treated as binary data. This makes it possible to collectively process the data in which the record data in the respective records are combined in descending order. For example, when the processing history information (log data) is stored in the record EF as records to which the record numbers are assigned one by one in order, it is possible to perform, by the binary-based command such as the read binary command, processing of, for example, collectively reading the log data by which information on a plurality of pieces of processing is arranged in descending order of history.

Next, the fourth example of processing in response to a binary-based command specifying the record EF will be described.

For example, the read binary command can be used as the binary-based command to read the data stored in the record EF as described above. When such a read binary command (binary-based command) specifying the record EF is received, data in which the management information and the record data in the respective records stored in the record EF specified by the command are combined in descending order is read as binary data in the fourth processing example.

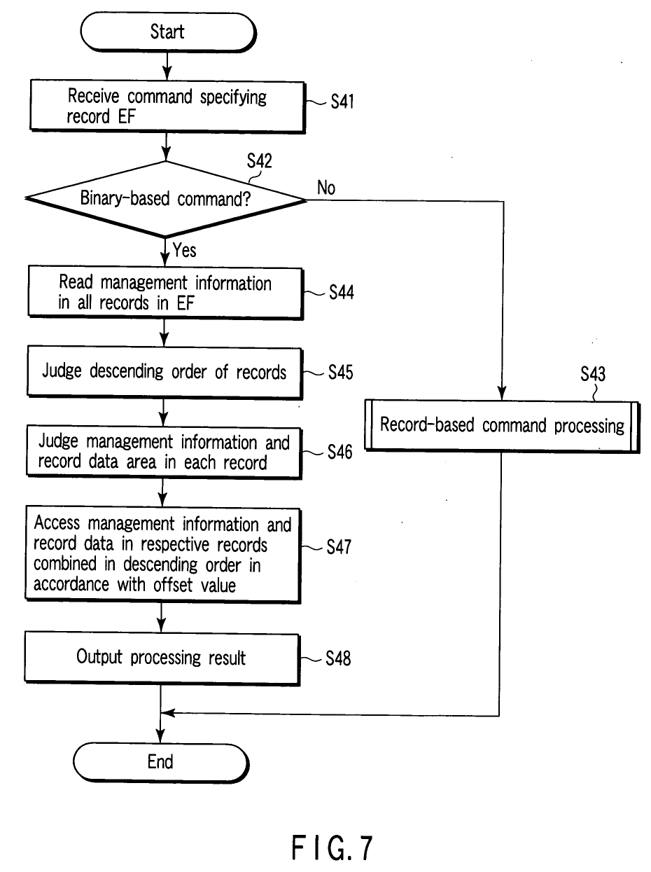

FIG. 7 is a flowchart for explaining the fourth processing example.

As shown in FIG. 7, the IC card 1 first receives a command (e.g., read command) specifying the record EF from the IC card processing device 2 (step S41). Then, the CPU 11 of the IC card 1 judges whether the received command is a record-based command (e.g., read record command) or a binary-based command (e.g., read binary command) (step S42).

When this judgment is that the received command is a record-based command (e.g., read record command) (step S42, NO), the CPU 11 of the IC card 1 executes the processing of (e.g., processing of reading) the record specified by the command among the records present in the record EF (step S43).

Furthermore, when the judgment is that the received command is a binary-based command (e.g., read binary command) (step S42, YES), the CPU 11 of the IC card 1 reads the management information for all the records present in the record EF specified by the command (step S44).

When the management information for all the records in the record EF is read, the CPU 11 judges the descending order of the records on the basis of the management information in the respective records (step S45). Here, the descending order of the records may be the descending order of date of the records when stored in the EF (or data of update of the record data) or may be the descending order of size of identification information of the records assigned to the records as the management information. For example, when the record numbers are assigned to the records in order in the record EF which stores the history of processing as records, the record data in the respective records are arranged in descending order of the record numbers, such that the management information and the processing history information are arranged in descending order of history.

Furthermore, the CPU 11 judges the descending order of the records, and also judges storage areas for the management information and the record data in each record on the basis of the management information for each record (step S46). The storage areas for the management information and the record data in each record are judged, for example, on the basis of the information (length) indicating the length of data stored in each record.

When the descending order of the records and the storage areas for the management information and the record data in each record have been judged, the CPU 11 executes the processing (e.g., reading processing) requested by the command for the data in which the management information and the record data in the respective records in the record EF are arranged in descending order (step S47). Moreover, an offset value indicating a start position of access is specified in the binary-based command (e.g., read binary command). Thus, in step S47, the CPU 11 performs the processing for data from the offset value specified by the command out of the data in which the management information and the record data in the respective records in the record EF are arranged in descending order (data combined in descending order).

When the processing requested by the binary-based command is terminated, the CPU 11 transmits a processing result as a response to the IC card processing device 2, and terminates the processing corresponding to the command (step S48). For example, when the received command is a read binary command whose offset value is n, the CPU 11 performs the processing of reading data from an n-th byte out of the data in which the management information and the record data in the respective records in the record EF are arranged in descending order, and transmitting the read data to the IC card processing device 2.

As a specific example of the fourth processing, a case will be described wherein a read binary command specifying the record EF as shown in FIG. 3 is received.

In this case, the IC card 1 in the fourth processing example reads, as binary data, data specified by the offset value out of the data in which the management information and the record data in the respective records are combined in the order (descending order) from the fourth record R4 to the first record R1, and outputs the data as a response to the read binary command.

For example, when the offset value of the read binary command specifying the record EF shown in FIG. 3 is “0”, the IC card 1 reads, as binary data, all the data in which the record data alone in the respective records are combined in the order (descending order) from the fourth record R4 to the first record R1. That is, in response to the read binary command specifying the record EF shown in FIG. 3 and having an offset value “0”, the IC card 1 in the fourth processing reads and outputs 60 bytes of data that are arranged in the following order: “53” to “57” (the management information R4a of the fourth record R4), “58” to “67” (the record data R4b of the fourth record R4), “38” to “42” (the management information R3a of the third record R3), “43” to “52” (the record data R3b of the third record R3), “23” to “27” (the management information R2a of the second record R2), “28” to “37” (the record data R2b of the second record R2), “08” to “12” (the management information R1a of the first record R1), and “13” to “22” (the record data R1b of the first record R1).

Furthermore, when the offset value of the read binary command specifying the record EF shown in FIG. 3 is “7”, the IC card 1 reads, as binary data, the data from the seventh byte out of the data in which the management information and the record data in the respective records are combined in the order (descending order) from the fourth record R4 to the first record R1. That is, in response to the read binary command specifying the record EF shown in FIG. 3 and having an offset value “7”, the IC card 1 in the fourth processing reads and outputs 53 bytes of data that are arranged in the following order: “60”, which is the data of the seventh byte from “53” (“53” to “57”, “58” to “59”), to “67” (data excepting five bytes of data of the management information R4a in the fourth record R4 and two bytes of data from the head of the record data R4b ), 38” to “52” (the management information R3a and the record data R3b of the third record R3), “23” to “37” (the management information R2a and the record data R2b of the second record R2), and “08” to “22” (the management information R1a and the record data R1b of the first record R1).

As described above, in the fourth processing example, when the record-based command specifying the record EF is received, a particular record in the EF specified by the command is accessed. When the binary-based command specifying the record EF is received, the data in which the management information and the record data in the respective records in the EF are combined in descending order is accessed.

That is, in the fourth processing example, when the record-based command specifying the record EF is received, the data in the EF is treated as a record EF to be processed for each of the specified records. When the binary-based command specifying the record EF is received, the data in which the management information and the record data in the respective records in the record EF are combined in descending order is processed as binary data. Thus, the record EF is treated as a pseudo transparent EF.

In this manner, according to the fourth processing example, it is possible to efficiently access the data stored in the record EF.

Furthermore, in the fourth processing example, when the binary-based command specifying the record EF is received, the data in which the management information and the record data in the respective records are combined in descending order is treated as binary data. This makes it possible to collectively process the data in which the management information and the record data in the respective records are combined in descending order. For example, when the processing history information (log data) is stored in the record EF as records to which the record numbers are assigned one by one in order, it is possible to perform, by the binary-based command such as the read binary command, processing of, for example, collectively reading the management information and the log data by which a plurality of pieces of processing is arranged in descending order of history.

Next, the fifth example of processing in response to a binary-based command specifying the record EF will be described.

In the fifth example, the configuration of data to be treated as the binary data is selected in accordance with, for example, parameters in the binary-based command specifying the record EF. That is, in the fifth processing example, the configuration of binary data (data for treating the record EF as a pseudo transparent EF) generated from the data in the record EF by the higher-level device is specified by the parameters in the binary-based command. In response to the binary-based command specifying the record EF, the IC card performs processing for the binary data having the configuration specified by the parameters of the command.

For example, in the first processing example, the data in which record data in the respective records in the record EF are combined in ascending order is treated as binary data. In the second processing example, the data in which the management information and the record data in the respective records in the record EF are combined in ascending order is treated as binary data. In the third processing example, the data in which record data in the respective records in the record EF are combined in descending order is treated as binary data. In the fourth processing example, the data in which the management information and the record data in the respective records in the record EF are combined in descending order is treated as binary data. In the present embodiment, as the fifth processing example, processing will be described wherein any one of the first to fourth processing examples is selectively executed on the basis of the parameters in the binary-based command.

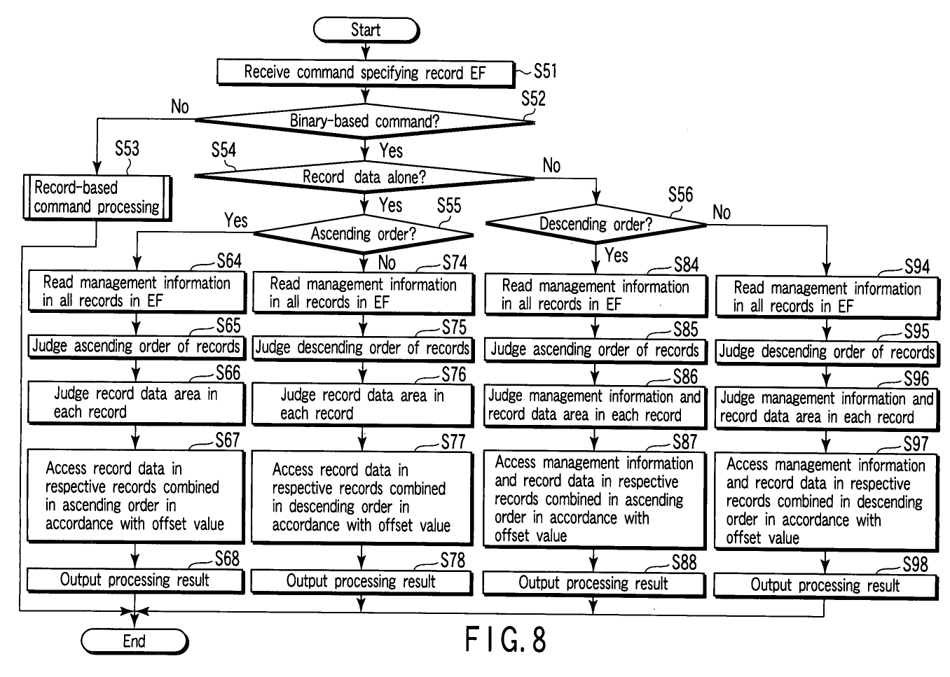

FIG. 8 is a flowchart for explaining the fifth processing example.

As shown in FIG. 8, the IC card 1 first receives a command (e.g., read command) specifying the record EF from the IC card processing device 2 (step S51). Then, the CPU 11 of the IC card 1 judges whether the received command is a record-based command (e.g., read record command) or a binary-based command (e.g., read binary command) (step S52).

When this judgment is that the received command is a record-based command (e.g., read record command) (step S52, NO), the CPU 11 of the IC card 1 executes the processing (e.g., reading processing) of the record specified by the command among the records present in the record EF (step S53).

Furthermore, when the judgment is that the received command is a binary-based command (e.g., read binary command) (step S52, YES), the CPU 11 of the IC card 1 further judges whether the data in the record EF has the configuration of the binary data in accordance with the parameters in the command (steps S54 to S56). That is, the CPU 11 of the IC card 1, on the basis of the parameters in the command, judges which part of each record is treated as the binary data (step S54), and also judges the order of combining the records (steps S55, S56).

For example, in the present embodiment, the CPU 11 judges whether to treat the data in which the record data in the respective records are combined in ascending order as binary data as in the first processing example, whether to treat the data in which the management information and the record data in the respective records are combined in ascending order as binary data as in the second processing example, whether to treat the data in which record data in the respective records are combined in descending order as binary data as in the third processing example, or whether to treat the data in which the management information and the record data in the respective records are combined in descending order as binary data as in the fourth processing example.

Here, when the judgment is to treat, as binary data, the data in which the record data in the respective records are combined in ascending order (YES in step S54, and YES in step S55), the CPU 11 reads the management information for all the records in the EF (step S64), judges the ascending order of the records (step S65), judges storage areas for the record data in each record (step S66), performs the processing for data from the offset value specified by the command out of the record data in the respective records that are combined in ascending order (step S67), and transmits the result of the processing to the IC card processing device 2 (step S68), as in steps S14 to S18 in FIG. 4 described in the first processing example.

Furthermore, when the judgment is to treat, as binary data, the data in which the management information and the record data in the respective records are combined in ascending order (NO in step S54, and YES in step S56), the CPU 11 reads the management information for all the records in the EF (step S74), judges the ascending order of the records (step S75), judges storage areas for the management information and the record data in each record (step S76), performs the processing for data from the offset value specified by the command out of the management information and the record data in the respective records that are combined in ascending order (step S77), and transmits the result of the processing to the IC card processing device 2 (step S78), as in steps S24 to S28 in FIG. 5 described in the second processing example.

Furthermore, when the judgment is to treat, as binary data, the data in which the record data in the respective records are combined in descending order (YES in step S54, and NO in step S55), the CPU 11 reads the management information for all the records in the EF (step S84), judges the descending order of the records (step S85), judges storage areas for the record data in each record (step S86), performs the processing for data from the offset value specified by the command out of the record data in the respective records that are combined in descending order (step S87), and transmits the result of the processing to the IC card processing device 2 (step S88), as in steps S34 to S38 in FIG. 6 described in the third processing example.

Furthermore, when the judgment is to treat, as binary data, the data in which the management information and the record data in the respective records are combined in descending order (NO in step S54, and NO in step S55), the CPU 11 reads the management information for all the records in the EF (step S94), judges the descending order of the records (step S95), judges storage areas for the management information and the record data in each record (step S96), performs the processing for data from the offset value specified by the command out of the management information and the record data in the respective records that are combined in descending order (step S97), and transmits the result of the processing to the IC card processing device 2 (step S98), as in steps S44 to S48 in FIG. 7 described in the fourth processing example.

As described above, in the fifth processing example, when the record-based command specifying the record EF is received, a particular record in the EF specified by the command is accessed. When the binary-based command specifying the record EF is received, the data in the respective records in the EF is accessed as the data having the configuration specified by the command.

That is, in the fifth processing example, when the record-based command specifying the record EF is received, the data in the EF is treated as a record EF to be processed for each of the specified records. When the binary-based command specifying the record EF is received, the data in the respective records in the record EF is processed as binary data having the configuration specified by the command. Thus, the record EF is treated as a pseudo transparent EF.

In this manner, according to the fifth processing example, it is possible to efficiently access the data stored in the record EF.

Furthermore, in the fifth processing example, when the binary-based command specifying the record EF is received, the data in the respective records are treated as the binary data having the configuration specified by the parameters or the like of the command. This makes it possible to access, as the binary data having a desired data configuration, the data stored as a plurality of records in the record EF.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A portable electronic device comprising:
a memory which stores files storing records having management information and record data;
a communication unit which performs data communication with an external device; and
a processing unit which processes, as binary data, data in the respective records stored in the file when receiving, through the communication unit, a binary command for binary data processing which specifies the file storing the records stored in the memory.

2. The portable electronic device according to claim 1, further comprising:
a module having the memory, the communication unit and the processing unit; and
a case in which the module is buried.

3. The portable electronic device according to claim 1, wherein
the processing unit processes, as binary data, the record data in the respective records stored in the file specified by the binary command.

4. The portable electronic device according to claim 1, wherein
the processing unit processes, as binary data, data in which the record data in the respective records stored in the file specified by the binary command are combined in ascending order.

5. The portable electronic device according to claim 3, wherein
the processing unit processes, as binary data, data in which the record data in the respective records stored in the file specified by the binary command are combined in descending order.

6. The portable electronic device according to claim 1, wherein
the processing unit processes, as binary data, the management information and the record data in the respective records stored in the file specified by the binary command.

7. The portable electronic device according to claim 6, wherein
the processing unit processes, as binary data, data in which the management information and the record data in the respective records stored in the file specified by the binary command are combined in ascending order.

8. The portable electronic device according to claim 6, wherein
the processing unit processes, as binary data, data in which the management information and the record data in the respective records stored in the file specified by the binary command are combined in descending order.

9. The portable electronic device according to claim 1, further comprising:
a judging unit which judges a data configuration used to process, as binary data, the data in the respective records stored in a file when receiving, through the communication unit, the binary command for the binary data processing which specifies the file storing the records stored in the memory,
wherein the processing unit processes, as binary data having the data configuration judged by the judging unit, the data in the respective records stored in the file specified by the binary command.

10. A control method for use in a portable electronic device, the method comprising:
receiving a command requesting data processing from an external device;
judging whether or not the command received from the external device is a binary command for binary data processing which specifies a file storing records stored in the memory and having management information and record data; and
processing, as binary data, the data in the respective records stored in the file when the command received from the external device is judged as the binary command which specifies the file storing the records.
